(19) United States
(12) Patent Application Publication
(10) Pub. No.: US 2006/0260876 A1
(43) Pub. Date: Nov. 23, 2006

(54) Stairlifts

(75) Inventor: Max Daniel Woodhams, Andover (GB)

Correspondence Address: Marina Larson & Associates, LLC, P.O. BOX 4928, DILLON, CO, 80435, US

(73) Assignee: STANNAH STAIRLIFTS LIMITED, Andover (GB)

(21) Appl. No.: 10/549,552

(22) PCT Filed: Mar. 3, 2004
(86) PCT No.: PCT/GB04/00877

§ 371 Date: Mar. 20, 2006

(30) Foreign Application Priority Data
Mar. 20, 2003 (GB) 0306367.4

(51) Int. Cl. B66B 9/08

(52) U.S. Cl. 187/201

(57) ABSTRACT

The invention provides a hand-operated interface through which a stairlift user can control the operation of the stairlift. The interface is configured for comfortable reception in the palm of the hand and its position may be adjusted along the axis of the armrest of the stairlift chair to best suit the arm length of the user. The interface may also incorporate an isolation switch which provides both a visual and a tactile indication of whether or not the stairlift controls are activated for use.

### FIELD OF THE INVENTION

This invention relates to stairlifts and, in particular, to a control interface through which a stairlift user may operate a stairlift.

### BACKGROUND TO THE INVENTION

Stairlifts are typically used by persons having limited mobility. The limitation in mobility often includes limited manual dexterity. This latter point is relevant when it comes to operating the stairlift, since the stairlift controls are almost universally hand operated.

One common form of operating control currently used on stairlifts comprises a joystick. Typically the joystick is positioned at the outer end of an armrest forming part of a stair lift chair. The joystick projects vertically upwards from the armrest and terminates in a knob or ball. The user must vertically rotate the wrist so as to locate the knob or ball in the palm of the hand. Once located, horizontal rotation of the wrist displaces the joystick so as to control the operation of the stair lift carriage.

The positioning of the joystick is generally convenient once the user is seated in the stair lift chair, although users with long forearms may find themselves having to displace their elbow rearward to an uncomfortable extent in order that the joystick may be accommodated comfortably in the palm of the hand. There is nothing which can be done to alleviate this problem since the joystick assembly is fixed into the armrest.

Often a stairlift user finds it necessary to steady themselves, when mounting the stairlift chair by, placing a hand on the armrest. The positioning of a joystick at the end of the armrest often interferes with this activity. Not only may the stairlift be unintentionally operated should the mounting user inadvertently bump the joystick but further, a joystick applies point loading to a user's palm and this loading would be accentuated to an intolerable level if a substantial part of the user's body weight was applied to the joystick when mounting the chair. Indeed, the joystick assembly might not survive a user's weight being applied thereto.

One common alternative to the joystick control described above, is the use of push-buttons on the armrest. As with the joystick control the positions of the push-buttons are fixed on the armrest and this may cause some discomfort to those having long forearms. Further, as with joystick controls, push-button controls are susceptible to inadvertent operation and it is generally recognized that push-buttons can be fiddly to operate, particularly by persons having impaired manual dexterity.

At least one attempt has been made to address some of the problems encountered with the controls described above. European Patent Application 0 915 952 describes a control interface for a stairlift in the form of a disc mounted on the outer end of a chair armrest. The disc has a convex upper surface which is comfortable for reception in the palm of a user's hand, however the lower edge of the disc forms a sharp edge which is so designed as to enable a user to hook the thumb under the control. For persons having limited manual dexterity, this action may prove difficult if not impossible, and it would certainly not be possible to wrap the hand around the control or to operate the control comfortably using the side of the hand. Further, the fixed position of the control on the armrest means that those users with longer forearms will still be susceptible to the types of discomfort mentioned above and, as with the forms on control mentioned above, this type of control may be operated inadvertently.

A further characteristic of existing stairlifts is that they almost invariably include a key to isolate the stairlift when not in use. In many cases this key is mounted on the underside of the armrest adjacent to the joystick and it can be very difficult for persons having limited hand dexterity to operate the key. Another problem with a key control is that it can be difficult to establish, at a glance, if the key is in the on or off position; and a user may complain that the stairlift is defective when, in fact, the only problem is that the key is in the off position.

It is an object of the present invention to provide controls, including an operating interface, for a stairlift which go at least some way in addressing at least some of the aforementioned problems; or which will at least provide a novel and useful choice.

### SUMMARY OF THE INVENTION

Accordingly, in a first aspect, the invention provides a stairlift chair including a pair of armrests, each of the said armrests having an upper surface; and a control interface mounted on one of said armrests, said chair being characterized in that said control interface has a palm contacting surface which forms a substantial extension of the upper surface of the armrest to which said interface is attached.

Preferably said control interface is pivotable about a substantially vertical axis.

Preferably said control interface is constructed and arranged to avoid point loading on a user's palm when in use.

Preferably said control interface has a substantially planar upper surface and side surfaces aligned substantially perpendicularly to said upper surface.

Preferably said one of said armrests has a longitudinal axis, the position of said control interface being adjustable along said longitudinal axis.

Preferably said control interface is angled upwardly out of the plane of said upper surface.

Preferably said control interface embodies a power isolation switch.

In a second aspect the invention provides a stairlift chair including two spaced armrests, each armrest having an rear end, a forward end, and a longitudinal axis; and a control interface positioned on or adjacent the forward end of one of said armrests, said chair being characterized in that the position of said control interface is adjustable along said longitudinal axis.

Preferably each of said armrests comprises a fixed rear part and a forward part which is slidable with respect to said rear part, said control interface being incorporated within said forward part.

In a third aspect the invention provides a manually engageable control interface for mounting on an armrest of a stair lift chair, said interface being characterized in that it is upwardly angled with respect to said armrest, includes a palm contacting surface constructed and arranged to avoid point loading on a user's palm, when in use and includes side surfaces configured to permit smooth contact by the side of a user's hand.

Preferably said palm contacting surface is constructed and arranged to underlie at least 50% of the area of a user's palm.

In a fourth aspect, the invention provides a manually engageable control interface for a stairlift, said interface including a body member engageable by a user's hand when said stairlift is in use, said interface being characterized in that said body member is formed in two parts which are displaceable with respect to one another such that, in a first configuration of said two parts, said control interface is inactive.

Preferably, when said body parts are in said first configuration, the resulting form of said body differs visually and/or provides a different tactile sensation to the user's hand than when said body parts are in an operative configuration.

In a fifth aspect the invention provides a stairlift including the chair and/or control interface as set forth above.

In a sixth aspect the invention provides stairlift assembly including:

a rail;

a carriage mounted for movement along said rail;

drive means within said carriage for driving said carriage along said rail;

a chair mounted on said carriage;

and at least one hand operated control whereby an occupant of said chair can control the operation of said drive means,

said stairlift assembly being characterized in that a sensor is provided to sense when a user is occupying said chair, said sensor being further operable to isolate and energise said hand operated control.

In an seventh aspect the invention provides a stairlift assembly including:

a rail;

a carriage mounted for movement along said rail;

drive means within said carriage for driving said carriage along said rail;

a chair mounted on said carriage;

at least one hand operated control whereby an occupant of said chair can control the operation of said drive means;

an isolation switch to isolate the power supply to said stairlift

said stairlift assembly being characterized in that said isolation switch is incorporated into said hand operated control.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be limited by the appended claims alone.

### BRIEF DESCRIPTION OF THE DRAWINGS

One preferred form of the invention will now be described with reference to the accompanying drawings in which:

FIG. 1: shows a side elevation of a stairlift assembly having a chair embodying the invention:

FIG. 2: shows a top view of a stairlift chair fitted with a control interface according to the invention.

FIG. 3: shows an enlarged side view of the control interface, and part of one armrest of the chair shown in FIG. 1:

FIG. 4: shows an isometric view, from above, of that which is shown in FIG. 3:

FIGS. 5 and 6: show isometric views of the control interface in two alternative configurations:

FIG. 7: shows a sectional view through the control interface when in the configuration shown in FIG. 5;

FIG. 8: shows a control interface according to the invention underlying the palm of a user's hand;

FIG. 9: shows a side view of a user's hand in contact with a control interface as described herein; and

FIG. 10: shows a view similar to that of FIG. 9 but with the user's hand positioned differently.

### DETAILED DESCRIPTION OF THE WORKING EMBODIMENT

According to the invention a control interface for a stairlift is provided whereby an occupant of the stairlift, having limited manual dexterity, can safely and confidently control the movement of the stairlift carriage along the rail. The same interface may simplify the task of isolating power to the stairlift and give a clear visual and/or tactile signal to the user when the stairlift is isolated. As described herein, this invention also includes an aspect intended to avoid inadvertent operation of the stairlift, particularly when the user is mounting or dismounting the stairlift chair.

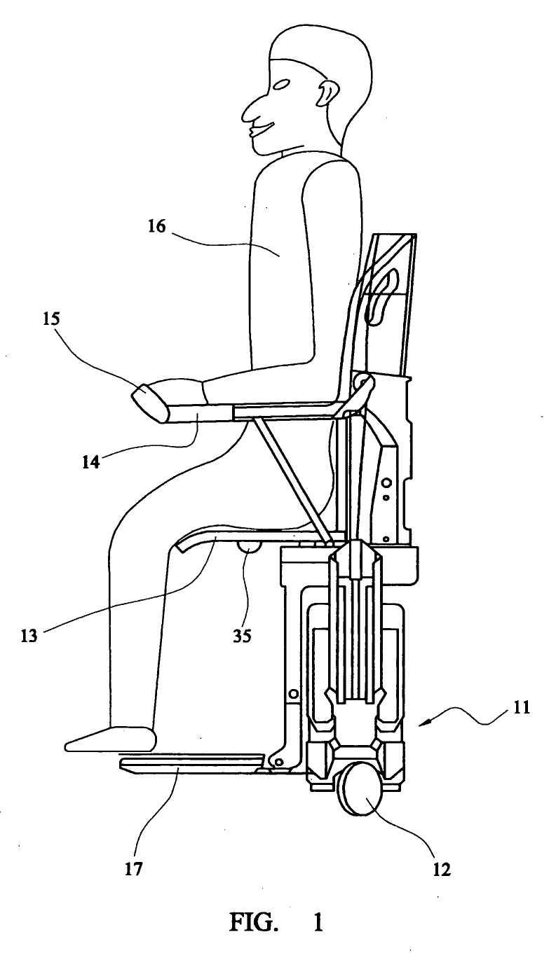

Referring firstly to FIGS. 1 and 2, a stairlift assembly is shown comprising a carriage 11 mounted on a rail 12 for movement there along. Mounted, in turn, on the carriage, is a chair 13. In common with conventional stairlift chairs, the chair 13 has a pair of spaced armrests 14a and 14b. Mounted on or adjacent the outer end of one of the armrests 14 (in this case armrest 14a) is a control interface 15. Whilst the control interface 15 could be a unit discrete from the armrest 14a, in the particular embodiment of the invention described herein, the interface 15 is preferably incorporated in a forward part of the armrest 14a. Thus, the control pod is conveniently positioned for contact and displacement by a user 16 seated in the chair 13.

The chair 13 further includes a footrest 17. In the known manner, the footrest 16 and the armrests 14 may be folded into vertically upright positions so that, when the stairlift is not in use, maximum clearance may be provided for foot traffic on the staircase.

Each of the armrests 14a and 14b is preferably formed in two parts, a fixed rear part 21 and a forward part 22 which is slidable or telescopic with respect to the rear part 21. Locking means (not shown) of any suitable form is provided to lock the forward part 22 with respect to the rear part 21. This arrangement allows the control interface 15 to be positioned to best suit the arm length of a particular user.

Once the length of armrest 14a has been set so as to correctly locate the control interface 15, the length of armrest 14b can be set so as to match the length of armrest 14a, thus leaving the user positioned evenly and comfortably.

The position of the interface 15 may be set other than purely for the ergonomic reasons described above. In installations on very narrow staircases, it may be necessary to draw the interface back or set the interface at an angle ø as shown in FIG. 2, to provide sufficient clearance between the stairlift installation and the staircase wall. Angle ø may, in extreme cases, be up to 45° if a particularly narrow stairway is encountered.

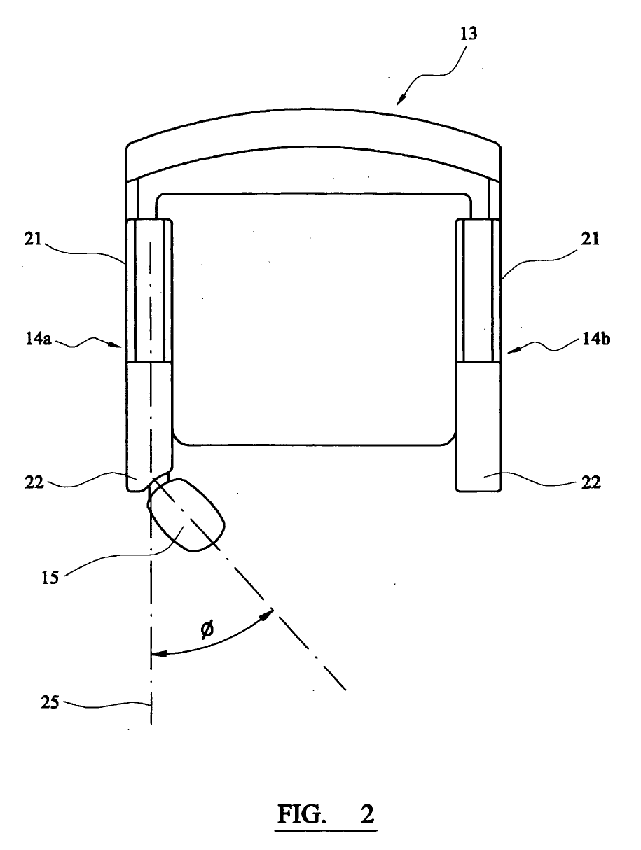

As can best be seen in FIG. 3 to 5, the control interface 15 comprises an elongate body which tapers towards its free end. This body is mounted to the front part 22 of armrest 14a so as to be pivotable about substantially vertical axis 24. The axis 24 is, itself, preferably positioned on the longitudinal centerline 25 of the armrest 14a.

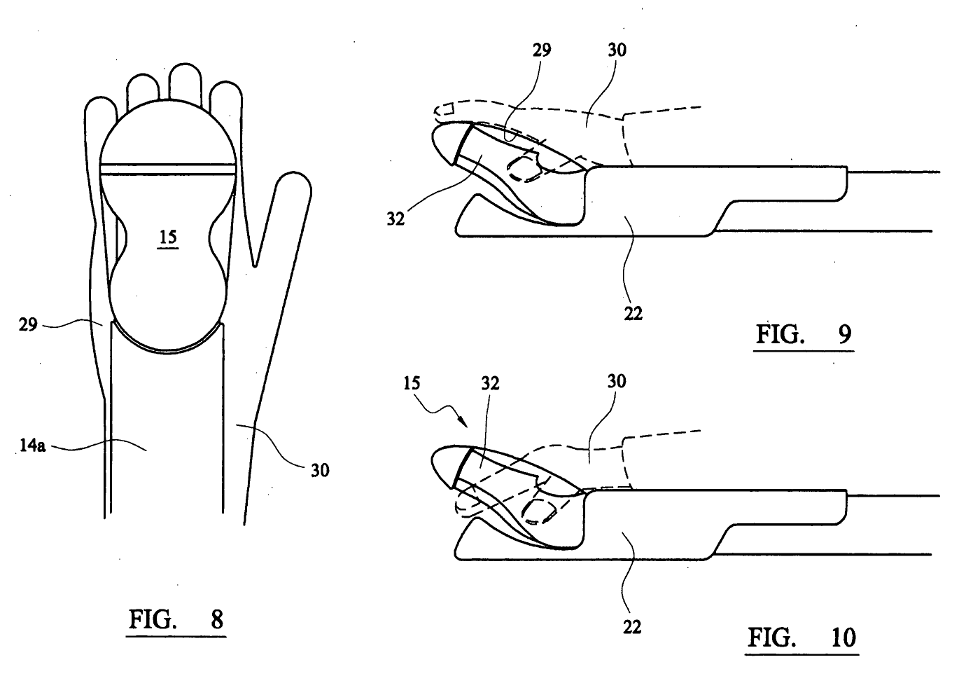

The interface has a substantially planar or slightly curved upper surface 27, the surface 27 being shaped for comfortable receipt in the palm 29 of a user's hand 30, as can be seen more clearly in FIGS. 8 and 9, and also being shaped to avoid any point loading on the palm 29. As can best be seen in FIGS. 3, 9 and 10, the upper surface 27 of the interface 15 is a substantially natural extension of the upper surface 23 of the armrest 14a, albeit at an angle to the plane of the surface 23. For a reason which will become more apparent from the description which follows below, the general alignment of interface 15 is angled upwardly at an angle of about 20°.

Projecting downwardly from the upper surface 27 are a pair of smooth, substantially vertical side surfaces 32.

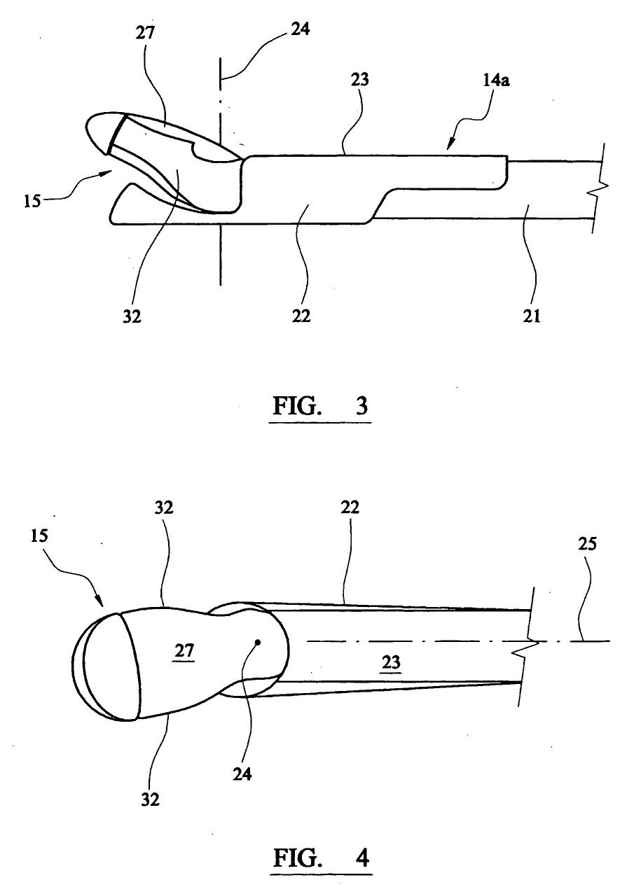

An internal spring (not shown) is preferably provided to return the control interface to a neutral position such as that shown in FIG. 4. Thus, in the conventional manner, pivoting the interface in one direction about pivot axis 24 causes the stair lift carriage to move in one direction. Pivoting the interface in the opposite direction causes the carriage to move in the opposite direction.

Referring particularly to FIG. 9, a user may operate the interface 15 by placing the palm 29 of the hand 30 in contact with the upper surface 27 of the interface, curling the hand over the interface, and rotating the wrist to effect pivotal movement of the interface about axis 24.

Some users, particularly those having limited manual dexterity, may have difficulty manipulating the interface 15 in the manner just described. These latter users may find it easier to nudge the interface about axis 24 by using the side of the hand against one of the side surfaces 32 of the interface, as shown in FIG. 10. This is particularly helpful to users who suffer from arthritis in the hands.

As can be seen in FIG. 8, the interface 15 underlies a substantial portion of the palm of a user's hand, in the form shown at least 50%.

As discussed in the background above, a problem with existing stairlift controls is that they can be operated inadvertently. This is most likely to occur when the user is mounting, or dismounting from, the stairlift chair. With this in mind, according to another aspect of the invention, a sensor is provided to sense when the user is seated in the chair. This sensor is provided in circuit with the operating controls so that the control interface 15 is only functional when the user is seated in the chair. This form of isolation could be provided in combination with any form of stairlift control, and not just with the particular form of control interface described herein.

In the form shown herein, the sensor comprises load sensor 35 provided in the chair base. A signal from the load sensor 35 is fed into the main operating control unit (not shown) which isolates the control interface 15 when the load sensor indicates that the chair is not occupied.

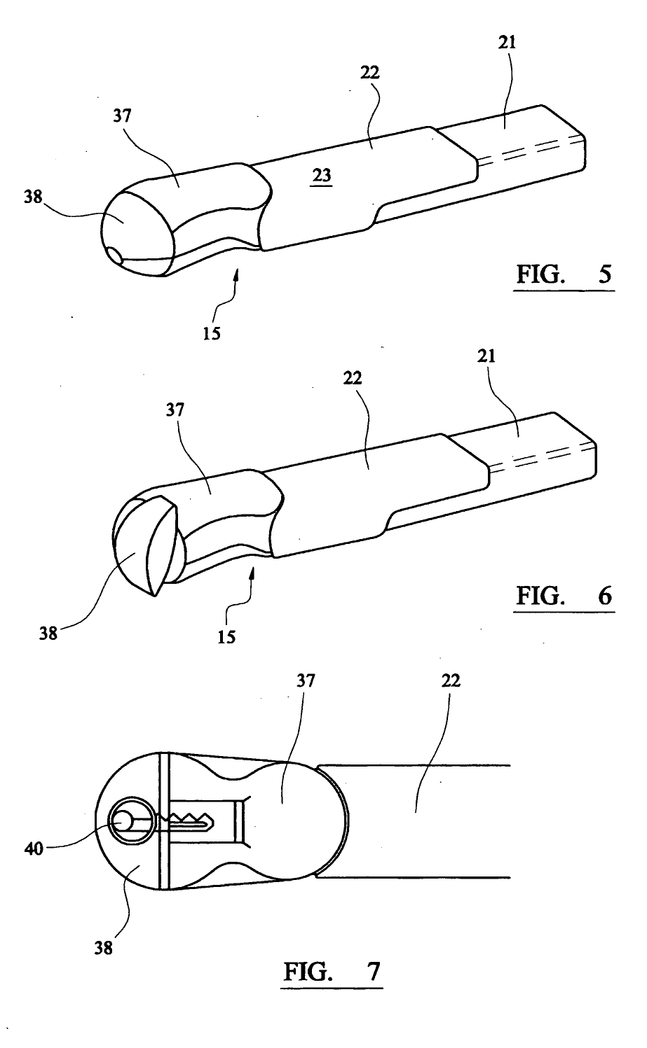

Turning now to FIGS. 5 to 7, it will be noted that the control interface 15 is preferably formed in two parts 37 and 38, the two parts being displaceable, and preferably rotatable, with respect to one another. When in the operating position, as shown in FIG. 6, the two parts provide one smooth contiguous body. However, when the stairlift is to be disarmed, the forward body part 38 is rotated with respect to the fixed body part 37. As can be seen in FIG. 7, embodied within the body 15 is a key assembly, the head of the key 40 being retained in the forward body part 38. Thus the forward body part 38 can be withdrawn to prevent unauthorised use of the stairlift.

A further benefit of the disabling or lock arrangement shown in FIGS. 5 to 7 is that the bulk of the forward body part 38 allows easy manipulation of the key lock by persons having limited hand dexterity. It will also be appreciated that, when the key is in the ‘off’ position as indicated in FIG. 6, the non-alignment of body part 38 gives a clear visual and/or tactile message to a user that the stairlift is immobilised. Thus a user can tell, at once, if the stairlift control is not configured for use. This applies whether the chair is extended or folded since the isolation control, being carried on the end of the interface 15, is fully visible at all times. This is in contrast to existing arrangements in which the control is located under the armrest and is thus, at best, only partially visible when the armrest is in the down or operative position.

In use, a stairlift user 16 mounts the stairlift chair 13 in the conventional manner though no harm will be done, or discomfort experienced, if the user supports himself on the interface 15 whist moving into the chair. Once seated in the chair 13, the user's presence will be sensed by sensor 35 and the control interface 15 enabled. If the interface 15 still does not operate, the user will readily be able to determine if the key switch is in the off position by visually noting the mis-alignment of interface body parts 37 and 38, and/or through the tactile sensation imparted to the hand by the mis-aligned parts.

With the control 15 energised, the user may power the carriage along the rail by applying the weight of the hand to the upper surface 18 of the interface, and pivoting the same about axis 24. The direction in which the interface is pivoted determines whether the carriage moves up or down the rail.

If the user finds it uncomfortable to bear down on the interface with the weight of his hand, then the user may nudge the interface about axis 24 using the side of the hand against the side of the interface. Obviously which side of the hand is applied against which side of the interface will determine the direction of movement of the carriage.

It will thus be appreciated that present invention provides an extremely useful form of control interface for a stairlift assembly which eases the entry on to, and exit from, the stairlift chair whilst providing easy operation of the stairlift by persons having limited hand dexterity. Further, the embodiment described herein provides a novel and inventive solution for avoiding inadvertent operation of the stairlift.

1. Stairlift, comprising:
a main frame;
support means for supporting this main frame such that it is movable along a support rail which is arranged at some height thereabove along a staircase;
a first electric motor for moving the main frame along the support rail; and
an auxiliary frame supported by the main frame for carrying a chair, for example a wheelchair, via a support platform such that the auxiliary frame is movable and fixable relative to the main frame by three auxiliary electric motors in two rotation degrees of freedom and one translation degree of freedom.

2. Stairlift as claimed in claim 1, wherein the first rotation degree of freedom is intended for up and downward pivoting of the auxiliary frame on a first, at least more or less horizontally extending axis.

3. Stairlift as claimed in claim 1, wherein the second rotation degree of freedom is intended for pivoting the auxiliary frame round a second axis extending substantially transversely of the rail and at least more or less in horizontal direction.

4. Stairlift as claimed in claims 2 and 3, wherein the first and the second axis are at least more or less intersecting.

5. Stairlift as claimed in claim 1, wherein the translation degree of freedom is intended for moving the auxiliary frame up and downward.

6. Stairlift as claimed in claim 1, wherein the three said degrees of freedom are mutually independent.

7. Stairlift as claimed in claim 1, comprising a battery.

8. Stairlift as claimed in claim 1, wherein on at least one end of the support rail is placed a terminal for a charging device which can co-act with a complementary terminal which is present on the stairlift and which is connected to the battery for charging the battery in the coupled state of said terminals.

9. Stairlift as claimed in claim 1, wherein the first electric motor drives a toothed wheel which can co-act with a toothing arranged on the support rail, for example a cardan fixed chain supported thereby.

10. Stairlift as claimed in claim 1, comprising a central control unit for operating by a user.

11. Stairlift as claimed in claim 10, wherein the central control unit is of the self-learning type.
